(19) United States
(12) Patent Application Publication
(10) Pub. No.: US 2023/0131914 A1
(43) Pub. Date: Apr. 27, 2023

(54) Air Fryer with Multiple Frying Baskets

(71) Applicant: GUANGDONG BRUCE TECHNOLOGY CO., LIMITED, Guangdong (CN)

(72) Inventor: Jingyun Liu, Guangdong (CN)

(21) Appl. No.: 17/584,634

(22) Filed: Jan. 26, 2022

(30) Foreign Application Priority Data
Oct. 25, 2021 (CN) 202111241298.1

(51) Int. Cl. A47J 37/06; F24C 15/32; F24C 7/08; A47J 36/32

(52) U.S. Cl. CPC A47J 37/0641; A47J 36/32; A47J 37/0664; F24C 7/085; F24C 7/087; F24C 15/322

(57) ABSTRACT

The present invention relates to the field of food processing technology, and more particularly to an air fryer with multiple frying baskets. The air fryer includes a housing provided with a cooking chamber, multiple heating members provided in the housing to heat the cooking chamber, a frying assembly, and multiple control systems provided in the housing. The frying assembly includes a first basket, multiple second baskets, and multiple front cover assemblies detachably connected to the first basket or the second baskets. The numbers of the second baskets, the front cover assemblies, the heating members, and the control systems are all the same. The second baskets are placed inside the first basket all at once. The cooking chamber is adapted to accommodate the first basket or to receive all of the second baskets. Each of the control systems is electrically connected to one of the heating members.

### BACKGROUND OF THE DISCLOSURE

### 1. Field of the Disclosure

The present invention relates generally to the field of food processing technology, and more particularly to an air fryer with multiple frying baskets.

### 2. Description of the Prior Art

Air fryers use air as a heat transfer carrier to effectively reduce the oil content of food and provide a healthy diet, so the use of air fryers is increasing. However, conventional air fryers usually have only one single pot of one specification. When it needs to process various types or sizes of food ingredients at once, different processing needs for different food ingredients can only be met by using multiple air fryers or waiting for several rounds. In other words, the one-pot design of conventional air fryers leads to several shortcomings, including higher costs in use, more occupied space, and longer processing time for food ingredients, and therefore cannot meet the needs of consumers. Improvements are required.

### SUMMARY OF THE DISCLOSURE

To overcome the shortcomings existing in current technologies, including the single specification of pot, time-consuming food processing, and high cost in use, the present invention provides an air fryer with multiple frying baskets. The air fryer provided in the present invention would occupy less space and lower the cost in use.

To achieve the above objectives, the technical solution of the present invention is:

An air fryer includes a hosing, which is provided with a cooking chamber, and includes a plurality of heating members, a frying assembly, and a plurality of control systems;

The heating members are provided in the housing and heat the cooking chamber;

The frying assembly includes a first basket, a plurality of second baskets, and a plurality of front cover assemblies. The number of the second baskets is at least two, and the number of the front cover assemblies is the same as that of the second baskets. The more than one second basket is placed in the first basket at once;

The front cover assemblies are detachably connected to the first basket or the second baskets;

The cooking chamber is adapted to accommodate the first basket or to accommodate the more than one second basket at the same time;

The number of the heating members is the same as that of the second baskets;

The number of the control systems is the same as that of the second baskets. The control systems are provided at the housing. Each of the control systems is electrically connected to one of the heating members.

Furthermore, the housing is provided with a plurality of lateral guide slots and at least one central guide slot. The lateral guide slots are provided in the cooking chamber, and are located at a top of the cooking chamber. The central guide slot is provided in the cooking chamber, and is located at the top of the cooking chamber. A number of the lateral guide slots is two, and the central guide slot is located between the two lateral guide slots. Two lateral guide slots are adapted to support the first basket. One of the lateral guide slots and one of the at least one central guide slot are adapted to support one of the second baskets.

Furthermore, each of the first and second baskets all includes a main body and a connecting member detachably connected to the main body. The connecting member is provided with a protrusion, which is separated from the main body by a distance;

Each of the front cover assemblies includes a cover, a handle, a button, an upper fixing plate, and a lower supporting plate, wherein the handle is detachably connected to the cover. The cover abuts against the main body of the corresponding first or second baskets. The button is provided at the handle to drive the upper fixing plate to reciprocate vertically relative to the corresponding protrusion. The lower supporting plate is provided at the handle, and holds the corresponding protrusion in cooperation with the upper fixing plate.

Furthermore, the button includes a left pushing block, a right pushing block, and a reset member. The left pushing block and the right pushing block are connected to the cover is a slidable manner, and are adapted to drive the upper fixing plate to move. The reset member is provided at the cover, and is adapted to drive the upper fixing plate to return to its original position.

Furthermore, the left pushing block is provided with a left sloping portion, and the right pushing block is provided with a right sloping portion. The left sloping portion and the right sloping portion are separated from each other by a distance. The upper fixing plate respectively abuts against the left sloping portion and the right sloping portion. The opening between the left sloping portion and the right sloping portion is narrower than a width of the upper fixing plate.

Furthermore, the upper fixing plate is L-shaped.

Furthermore, the lower supporting plate includes a first side board, a bottom board, and a second side board which are sequentially connected. The first side board and the second side board are located on a same side of the bottom board. A top of the second side board is separated from a bottom of the upper fixing plate by a distance.

Furthermore, the housing is further provided with a positioning block, which is provided at a bottom of the cooking chamber. The positioning block is adapted to block the front cover assemblies.

The benefits of the present invention: by providing multiple heating members and control systems, and with the frying assembly which includes a first basket and multiple second baskets, the multiple second baskets can be received in the first basket at the same time, which could reduce the cost in use and the occupied space, whereby to meet the different requirements of various consumers.

### BRIEF DESCRIPTION OF THE DRAWINGS

The present invention will be best understood by referring to the following detailed description of one illustrative embodiment in conjunction with the accompanying drawings, in which

FIG. 1 is a schematic view showing the three-dimensional structure of the present invention;

FIG. 2 is an exploded view showing the structure of the present invention;

FIG. 3 is a sectional perspective view showing the use condition of the second baskets of the present invention;

FIG. 4 is a partial enlarged view of part A in FIG. 3;

FIG. 5 is a partial enlarged view of part B in FIG. 3;

FIG. 6 is an exploded view showing the structure-in-use of the second baskets in the present invention;

FIG. 7 is a perspective sectional view showing the use condition of the first basket of the present invention;

FIG. 8 is an exploded view showing the structure-in-use of the first basket of the present invention;

FIG. 9 is an exploded view seen from a first view angle which illustrates the first basket and the front cover assemblies;

FIG. 10 is an exploded view seen from a second view angle which illustrates the first basket and the front cover assemblies;

FIG. 11 is an exploded view seen from a first view angle which illustrates the second basket and the front cover assemblies;

FIG. 12 an exploded view seen from a second view angle which illustrates the second basket and the front cover assemblies;

FIG. 13 is a perspective view showing the button, the upper fixing plate, and the lower supporting plate of the present invention;

FIG. 14 is a sectional view showing the button, the upper fixing plate, and the lower supporting plate of the present invention;

FIG. 15 is a schematic view showing the components of the present invention; and

FIG. 16 is a sectional view showing part of the present invention.

### DETAILED DESCRIPTION

To facilitate the understanding of those skilled in the art, the present invention will be further described below with embodiments and accompanying drawings. The contents mentioned in the embodiments are not intended to limit the present invention.

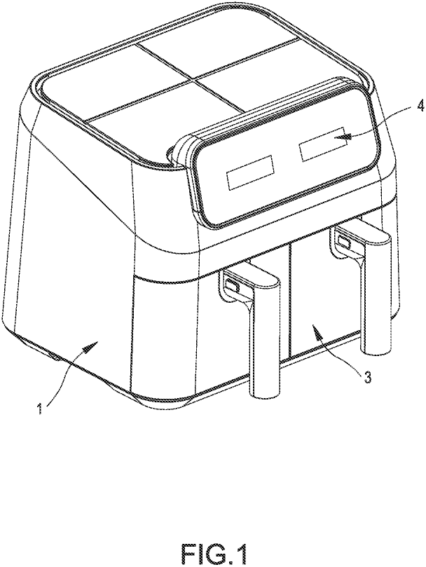

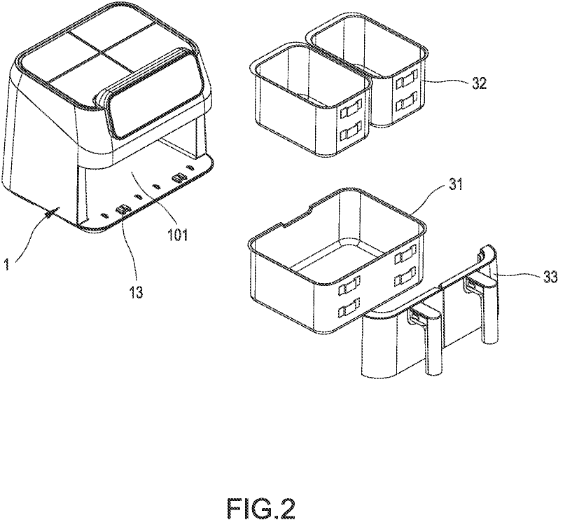

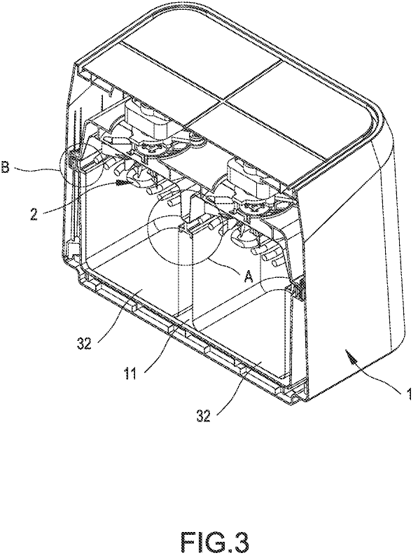

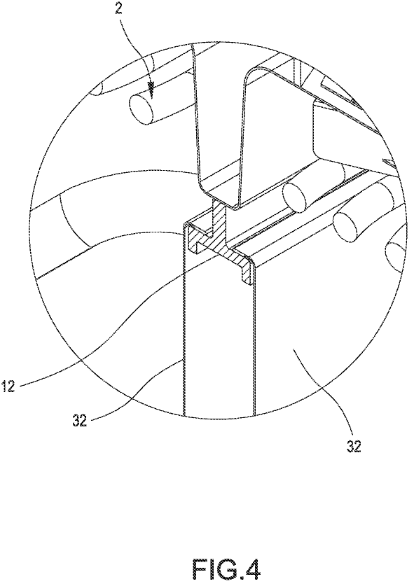

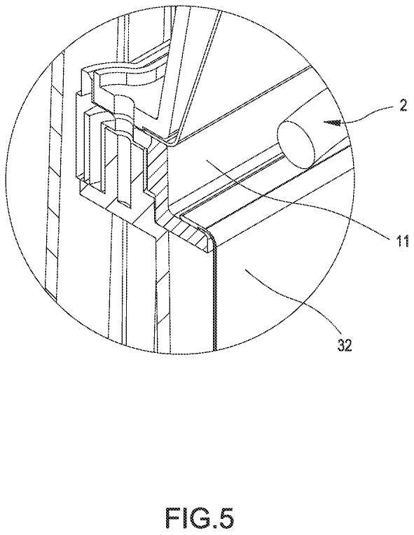

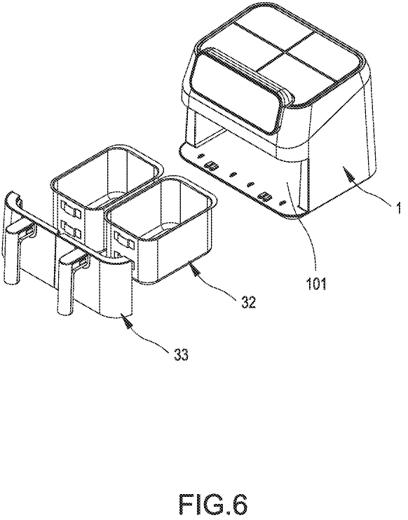

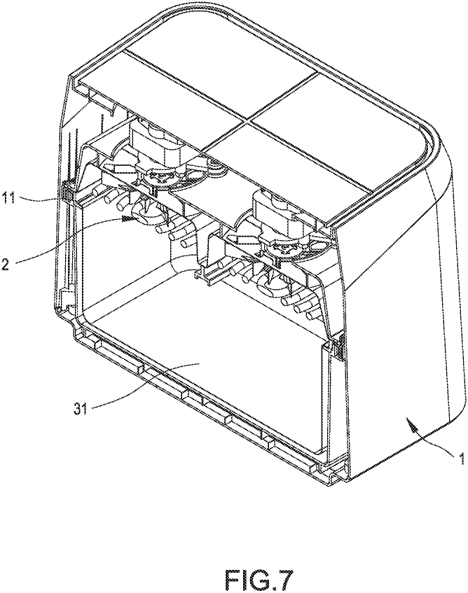

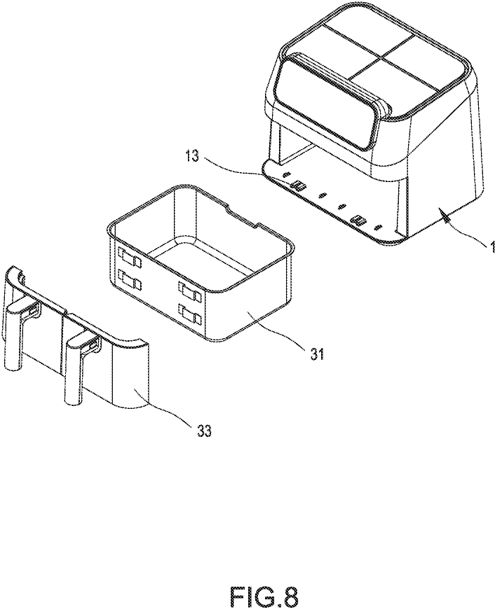

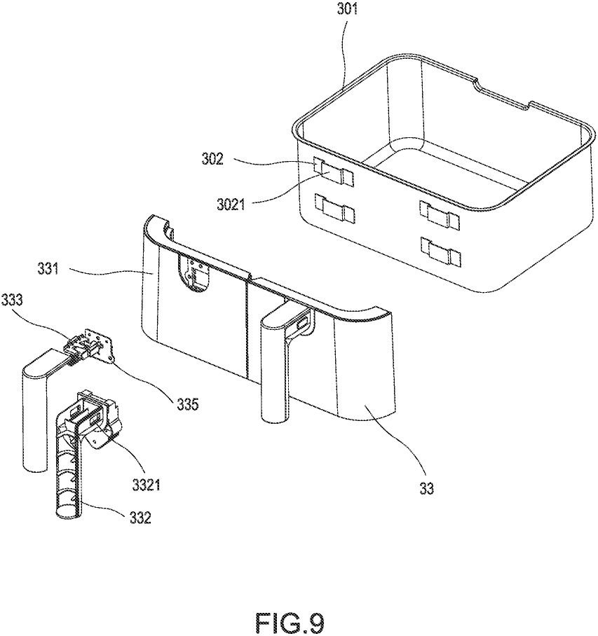

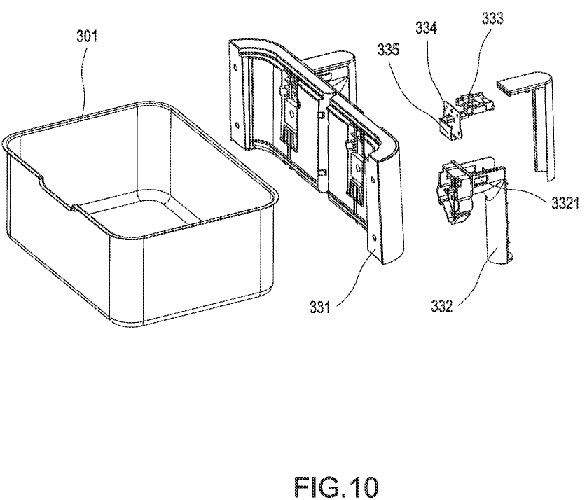

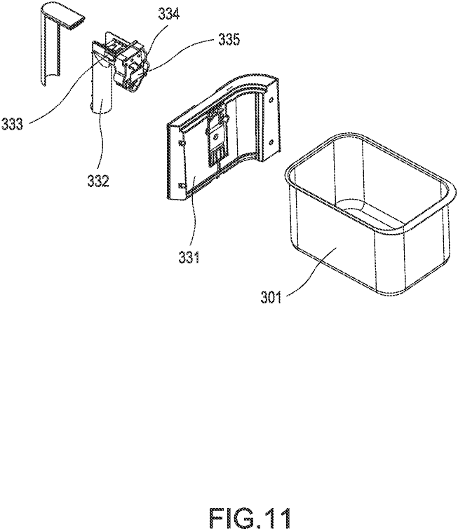

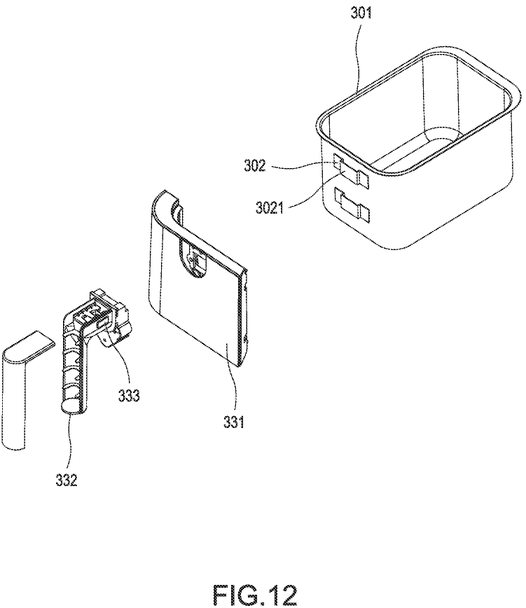

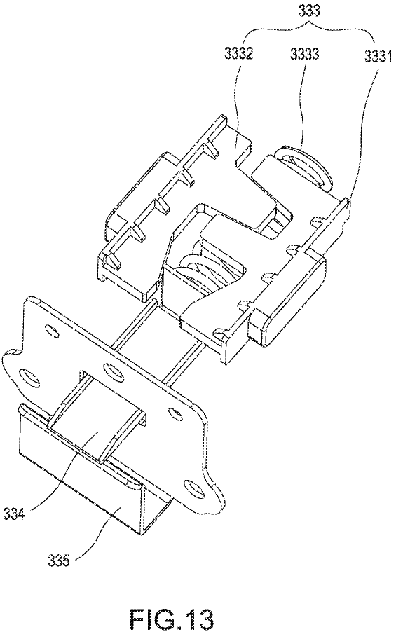

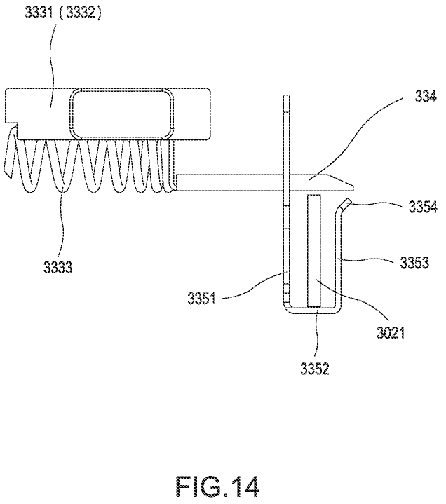

As shown in FIG. 1 to FIG. 14, an air fryer with multiple frying baskets provided in the present invention includes a housing 1, which is provided with a cooking chamber 101, and further includes a plurality of heating members 2, a frying assembly 3, and a plurality of control systems 4.

The heating members 2 are provided at the housing 1, and heat the cooking chamber 101.

The frying assembly 3 includes a first basket 31, a plurality of second baskets 32, and a plurality of front cover assemblies 33. A number of the second baskets 32 is at least two. A number of the front cover assemblies 33 is the same as the number of the second baskets 32. The more than one second basket 32 is placed in the first basket 31 at once.

The front cover assemblies 33 is detachably connected to the first basket 31 or the second baskets 32.

The cooking chamber 101 is adapted to accommodate the first basket 31 or to accommodate the more than one second basket 32.

A number of the heating members 2 is the same as the number of the second baskets 32.

A number of the control systems 4 is the same as the number of the second baskets 32. The control systems 4 are provided at the housing 1, wherein each of the control systems 4 is electrically connected to one of the heating members 2.

Specifically, in the current embodiment, the housing 1 is made by assembling multiple plastic members, and each of the heating members 2 includes a metal heating plate and a heat dissipation member. The metal heating plate is installed at the housing 1, and is located at a top of the cooking chamber 101. The heat dissipation member is located behind the metal heating plate. A temperature detecting member is further installed at the housing 1, and is located directly in front of the metal heating plate to ensure that the metal heating plate works normally. The control systems 4 are smart control modules. Preferably, the number of the heating members 2 is two, and the two heating members 2 are provided in parallel and separated from each other by a distance. A number of the first basket 31 is one, and the number of the second baskets 32 is two. In addition, the number of the front cover assemblies 33 is two, and the number of the control systems 4 is two. When it needs to cook more or larger food ingredients, the first basket 31 would be selected, with the two front cover assemblies 33 both connected to the first basket 31. By placing the food ingredients inside the first basket 31 and activating the two control systems 4 of the same configurations, the purpose of cooking more or larger food ingredients could be realized. When processing food ingredients of various types which requires different processing temperatures and processing times, these different kinds of food ingredients could be placed into the two second baskets 32, respectively, wherein each of the second baskets 32 is assembled with one of the front cover assemblies 33, so that the second baskets 32 could be conveniently fetched. Preferably, each of the heating members 2 is located directly above one of the second baskets 32. By respectively setting different cooking temperatures and times for each of the control systems 4, the requirement of processing food ingredients of different types could be achieved. When the air fryer is to be stored, the two second baskets 32 could be placed in the first basket 31, and the two front cover assemblies 33 are both installed in the first basket 31. Just push the first basket 31 into the cooking chamber 101, and the total volume of the air fryer would be no bigger than a conventional air fryer. In this way, the air fryer provided in the present invention could reduce the cost in use, and would be convenient for storage at the same time.

By providing multiple heating members 2 and control systems 4, and by designing the frying assembly 3 to include a first basket 31 and multiple second baskets 32 which can be accommodated inside the first basket 31, the air fryer could reduce the cost in use and would occupy less space, which would meet the different requirements of various consumers.

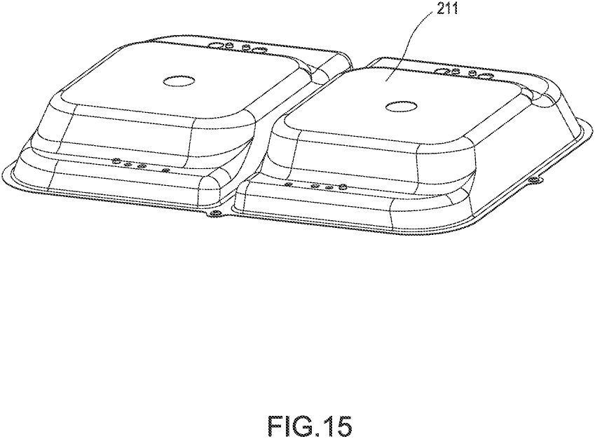

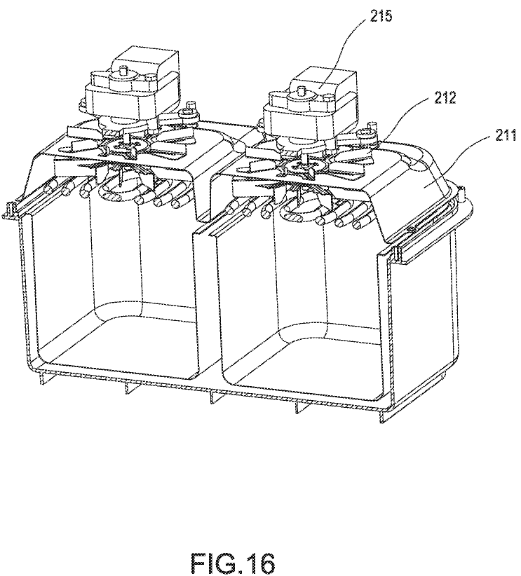

As shown in FIG. 15 and FIG. 16, each of the heating members 2 cooperates with a circulation module, which includes an airflow cover 211, a circulation vane module 212, a driving module 215, which is electrically connected to one of the control systems 4, respectively. The circulation vane module 212 is connected to a rotary shaft of the driving module 215. The airflow cover 211 is a thin shell having recesses corresponding to the first basket 31 or the second baskets 32. In the current embodiment, the airflow cover 211 corresponding to the two second baskets 32 is made integrally, and a section thereof resembles a M shape, so that the airflow cover 211 forms two recesses. Each of the recesses of the airflow cover 211 corresponding to one of the second baskets 32 accommodates the corresponding heating member 2 therein. The circulation vane module 212 includes two sets of airflow vane units, which are respectively provided on upper and lower surfaces of the airflow cover 211, wherein the airflow vane unit located at the lower surface and in one of the recesses is between one of the heating members 2 and the airflow cover 211. Preferably, the rotary directions of paired airflow vane units are opposite, wherein the opposite rotary directions of the vanes could balance the driving module 215, and could heat the food ingredients while cooling the corresponding control system 4. When in use, each of the heating members 2 and each of the driving modules 215 are respectively connected to the corresponding one of the control systems 4, wherein the control systems 4 would be respectively controlled to cook the food ingredients placed inside the corresponding second baskets 32 with different conditions. In this way, food ingredients of different types could have the appropriate air-frying effects of different extents of high-speed heat circulation. An inner surface of the airflow cover 211 could be coated with heat-reflective materials so that the airflow vane units could perform a great amount of heat circulation to the food ingredients.

The housing 1 is provided with a plurality of lateral guide slots 11 and at least one central guide slot 12. The lateral guide slots 11 are provided in the cooking chamber 101 and located at the top of the cooking chamber 101. The central guide slot 12 is provided in the cooking chamber 101 and is located at the top of the cooking chamber 101. A number of the lateral guide slots 11 is two, and the central guide slot 12 is located between the two lateral guide slots 11. The two lateral guide slots 11 are adapted to support the first basket 31, while one of the lateral guide slots 11 and one of the at least one central guide slot 12 are adapted to support one of the second baskets 32. Preferably, a number of the central guide slot 12 is one. The central guide slot 12 is H-shaped, and one of the at least one central guide slot 12 is placed at the middle portion of the top of the cooking chamber 101. The number of the lateral guide slots 11 is two, and are respectively located on two sides of the top of the cooking chamber 101. The lateral guide slots 11 and the central guide slot 12 are located at a same altitude, which would be convenient for the first basket 31 or the second baskets 32 to smoothly slide into the cooking chamber 101 along with the lateral guide slots 11 and the central guide slot 12.

Each of the first and second baskets 31, 32 all includes a main body 301 and a connecting member 302 detachably connected to the main body 301. The connecting member 302 is provided with a protrusion 3021, which is separated from the main body 301 by a distance. The connecting member 302 is made of an iron plate, and the connecting member 302 is substantially U-shaped, wherein two ends of the connecting member 302 abut against and connected to the main body 301 through screws. A middle part of the connecting member 302 is the protrusion 3021 separated from the main body 301 by the distance.

Each of the front cover assemblies 33 includes a cover 331, a handle 332, a button 333, an upper fixing plate 334, and a lower supporting plate 335, wherein the handle 332 is detachably connected to the cover 331, which abuts against the main body 301 of the corresponding first and second baskets 31, 32. The button 333 is provided at the handle 332, and is adapted to drive the upper fixing plate 334 to reciprocate vertically relative to the protrusion 3021. The lower supporting plate 335 is provided at the handle 332, and holds the protrusion 3021 of the corresponding first and second baskets 31, 32 in cooperation with the upper fixing plate 334. The cover 331 is adapted to cover a front part of the main body 301 of the corresponding first and second baskets 31, 32, which keeps the main body 301 from being exposed. The handle 332 is L-shaped and is connected to the cover 331 through screws. The handle 332 includes an outer case and a and a bottom case, wherein the outer case and the bottom case form an inner chamber therebetween. The bottom case is provided with a through hole 3321, which communicates with the inner chamber. A primary body of the button 333 passes through the through hole 3321 for convenient operation. By pressing the button 333, the button 333 would push the upper fixing plate 334 to move in a direction away from the corresponding main body 301. Since the upper fixing plate 334 is away from a direct top of the corresponding protrusion 3021, the corresponding protrusion 3021 would be no longer held, and the front cover assembly 33 would therefore be disengaged from the corresponding main body 301. When it needs to assemble the components, the lower supporting plate 335 should approach a lower end of the protrusion 3021 first. With the effect of the button 333, the upper fixing plate 334 could be then moved to the direct top of the protrusion 3021, and the upper fixing plate 334 and the lower supporting plate 335 would hold the corresponding protrusion 3021 again, whereby to assemble the manipulated front cover assembly 33 and the corresponding main body 301.

The button 333 includes a left pushing block 3331, a right pushing block 3332, and a reset member 3333. The left pushing block 3331 and the right pushing block 3332 are connected to the cover 331 in a slidable manner, and are adapted to drive the upper fixing plate 334 to move. The reset member 3333 is provided at the cover 331 and is adapted to drive the upper fixing plate 334 to return to its original position. The reset member 3333 is a spring. When the left pushing block 3331 and the right pushing block 3332 approach each other, the upper fixing plate 334 is pushed to move, so that the upper fixing plate 334 leaves the direct top of the protrusion 3021. Once the force exerted to the left pushing block 3331 and the right pushing block 3332 dismisses, the spring releases its elasticity, pushing the upper fixing plate 334 to move, which makes the upper fixing plate 334 back to the direct top of the protrusion 3021. As a result, the upper fixing plate 334 and the lower supporting plate 335 could hold the protrusion 3021 together, whereby to disengage the front cover assemblies 33 from the first basket 31 or the second baskets 32.

The lower supporting plate 335 is connected to the handle 332, and the lower supporting plate 335 is provided with a through hole thereon. The upper fixing plate 334 passes through the through hole on the lower supporting plate 335. The lower supporting plate 335 has a larger area, which increases a contact area between the lower supporting plate 335 and the handle 332 and therefore improves the fixability. With the through hole provided on the lower supporting plate 335, the upper fixing plate 334 could be conveniently moved.

The left pushing block 3331 is provided with a left sloping portion, and the right pushing block 3332 is provided with a right sloping portion. The left sloping portion and the right sloping portion are separated from each other by a distance. The upper fixing plate 334 respectively abuts against the left sloping portion and the right sloping portion. An opening formed between the left sloping portion and the right sloping portion is narrower than a width of the upper fixing plate 334. This kind of moving mechanism is simple and easy to operate, and it is easy to be processed with a low manufacturing cost.

The upper fixing plate 334 is L-shaped. A vertical portion of the upper fixing plate 334 abuts against the button 333, while a horizontal portion of the upper fixing plate 334 is adapted to move horizontally, whereby to hold the corresponding protrusion 3021 in cooperation with the lower supporting plate 335.

The lower supporting plate 335 includes a first side board 3351, a bottom board 3352, and a second side board 3353 which are sequentially connected. The first side board 3351 and the second side board 3353 are located on a same side of the bottom board 3352. A top of the second side board 3353 is separated from a bottom of the upper fixing plate 334 by a distance. The second side board 3353 is further provided with a bent portion 3354. The bent portion 3354 tilts in a direction away from the first side board 3351, which could increase the fixability and resistance against deformation. The lifespan of use could be extended as a result.

The housing 1 is further provided with a positioning block 13, which is provided at a bottom of the cooking chamber 101. The positioning block 13 is adapted to block the front cover assemblies 33. Furthermore, the positioning block 13 is also adapted to position the front cover assemblies 33, ensuring that the first basket 31 or the second baskets 32 are placed at predetermined positions, whereby to fully utilize the power of the heating members 2 and achieve the best use effect.

The above contents are only several embodiments of the present invention. For those of ordinary skill in the art, though based on the concepts of the present invention, specific implementations and scopes of application may be still subject to change. The content in the specification shall not be deemed limitations.

What is claimed is:

1. An air fryer, comprising:
a housing provided with a cooking chamber, wherein the housing comprises a plurality of heating members, a frying assembly, and a plurality of control systems; each of the heating members is respectively provided in the housing, and respectively provides high-speed heat circulation to heat the cooking chamber; each of the heating members is respectively connected to one of the control systems, and is driven by the connected control system to separately heat a different part of the cooking chamber with high-speed heat circulation;
wherein the frying assembly comprises a plurality of baskets and a plurality of front cover assemblies;
wherein the front cover assemblies are detachably connected to the baskets;
wherein the cooking chamber is adapted to accommodate the baskets;
wherein a number of the heating members is the same as a number of the baskets;
wherein the control systems are provided at the housing, and the control systems are electrically connected to the heating members.

2. The air fryer of claim 1, wherein the control systems respectively control the correspondingly connected heating members; each of the heating members is provided with an airflow cover at a corresponding location, wherein each of the airflow covers comprises a recess to accommodate the corresponding heating member.

3. The air fryer of claim 2, wherein a number of the control systems is the same as the number of the baskets; the number of the baskets is at least two; a number of the front cover assemblies is the same at the number of the baskets; the more than one basket is placed in another basket at the same time.

4. The air fryer of claim 3, wherein a section of each of the airflow covers is M-shaped, which comprises the recess and another recess to correspondingly accommodate the corresponding heating member; an airflow vane unit is provided between each of the heating members and the corresponding airflow cover, whereby to provide the heat circulation for heating.

5. The air fryer of claim 3, wherein each of the heating members corresponds to a driving module and two airflow vane units which are connected to the driving module and have opposite rotating directions; the airflow vane units are respectively placed at upper and lower surfaces of the corresponding airflow cover.

6. The air fryer of claim 5, wherein the housing is provided with a plurality of lateral guide slots and at least one central guide slot; the lateral guide slots are provided in the cooking chamber, and are located at a top of the cooking chamber; the central guide slot is provided in the cooking chamber, and is located at the top of the cooking chamber; a number of the lateral guide slots is two, and the central guide slot is located between the two lateral guide slots; the two lateral guide slots are adapted to support the another basket; one of the lateral guide slots and one of the at least one central guide slot are adapted to support one of the baskets.

7. The air fryer of claim 6, wherein each of the baskets and the another basket all comprises a main body and a connecting member detachably connected to the main body; the connecting member is provided with a protrusion, which is separated from the main body by a distance;
wherein each of the front cover assemblies comprises a cover, a handle, a button, an upper fixing plate, and a lower supporting plate; the handle is detachably connected to the cover; the cover abuts against the main body of the corresponding baskets or the another basket; the button is provided at the handle to drive the upper fixing plate to reciprocate vertically relative to the corresponding protrusion; the lower supporting plate is provided at the handle, and holds the corresponding protrusion in cooperation with the upper fixing plate.

8. The air fryer of claim 7, wherein the button comprises a left pushing block, a right pushing block, and a reset member; the left pushing block and the right pushing block are connected to the cover is a slidable manner, and are adapted to drive the upper fixing plate to move; the reset member is provided at the cover, and is adapted to drive the upper fixing plate to return to its original position.

9. The air fryer of claim 8, wherein the left pushing block is provided with a left sloping portion, and the right pushing block is provided with a right sloping portion; the left sloping portion and the right sloping portion are separated from each other by a distance; the upper fixing plate respectively abuts against the left sloping portion and the right sloping portion; an opening between the left sloping portion and the right sloping portion is narrower than a width of the upper fixing plate.

10. The air fryer of claim 8, wherein the upper fixing plate is L-shaped.

11. The air fryer of claim 8, wherein the lower supporting plate comprises a first side board, a bottom board, and a second side board which are sequentially connected; the first side board and the second side board are located on a same side of the bottom board; a top of the second side board is separated from a bottom of the upper fixing plate by a distance.

12. The air fryer of claim 1, wherein the housing is further provided with a positioning block, which is provided at a bottom of the cooking chamber; the positioning block is adapted to block the front cover assemblies.
